(19) United States
(12) Patent Application Publication
(10) Pub. No.: US 2005/0035319 A1
(43) Pub. Date: Feb. 17, 2005

(54) Hydraulic control system for vehicle

(76) Inventor: Satoshi Sanada, Kariya-city (JP)

Correspondence Address: POSZ & BETHARDS, PLC, 11250 ROGER BACON DRIVE, SUITE 10, RESTON, VA, 20190, US

(21) Appl. No.: 10/944,723

(22) Filed: Sep. 21, 2004

Related U.S. Application Data
(63) Continuation-in-part of application No. 10/889,044, filed on Jul. 13, 2004.

(30) Foreign Application Priority Data
Jul. 30, 2003 (JP) 2003-282884

(51) Int. Cl. F16K 31/02

(52) U.S. Cl. 251/129.01

(57) ABSTRACT

A solenoid cover includes a solenoid valve housing chamber housing of solenoid valves that project outwards from a hydraulic unit housing and a lower space therebelow. An upper volume reduced portion is disposed upper side of a solenoid valve position region. Since the upper volume reduced portion is formed such that a part of the partition protrudes toward the hydraulic unit housing, a volume of the upper space, which is sandwiched between the upper volume reduced portion and the hydraulic unit housing, becomes extremely small. Accordingly, the total volume of the solenoid valve housing chamber is reduced by providing the upper volume reduced portion and the absolute amount of water to be entered reduces. A height level of the water that is entered in the solenoid valve housing chamber is suppressed.

### CROSS REFERENCE TO RELATED APPLICATION

This application is a continuation-in-part application of application Ser. No. 10/889,044 filed on Jul. 13, 2004, the content of which are incorporated herein by reference.

### FIELD OF THE INVENTION

The present invention relates to a hydraulic control system for a vehicle.

### BACKGROUND OF THE INVENTION

Conventionally, a vehicle has a hydraulic control system which includes a hydraulic unit for regulating a wheel cylinder pressure by actuating a solenoid valve, a pump motor which serves as an actuator for regulating a hydraulic pressure, an electronic control system which controls the hydraulic unit and drives the pump motor, and the like. In order to reduce the size of the hydraulic control system, the hydraulic unit, the pump motor and the electronic control system are integrated into a module.

In a hydraulic control system like this, it is particularly important that a solenoid portion of the solenoid valve is not exposed to water and dust in order to prevent a breakdown or corrosion. To achieve this objective, the solenoid portion could be disposed in an air-tight chamber. However, when an in-vehicle air-tight chamber is subjected to a severe temperature change, water vapor is likely to enter the air-tight chamber and dew is likely to condense therein.

In order to address this problem, a solenoid valve housing chamber for housing a solenoid portion of the solenoid valve usually includes an air vent. The air vent allows water to enter a solenoid valve housing chamber and facilitates draining of the water that has entered (for example, as disclosed in Japanese Patent Application Laid-Open 2001-124005).

There are some cases where water entry into the solenoid valve housing chamber having an air vent like this occurs because the air vent is immersed in water, whereby water pressure is applied to the air vent. Another reason for water entry is as follows. When the temperature of the solenoid valve housing chamber installed in an engine room is relatively high in accordance with an actuation state of the solenoid valve, and if a case in which the solenoid valve housing chamber gets wet due to water on a road surface being splashed thereof, the temperature in the solenoid valve housing chamber drops. When the pressure in the solenoid valve housing chamber becomes negative pressure due to a sudden temperature change like this, water which has splashed onto the case in the vicinity of the air vent is sucked into the solenoid housing chamber by the negative pressure, whereby water enters the solenoid valve housing chamber.

In the above described conventional art, an air passage that is repeatedly bonded to form a labyrinth structure formed is used to communicate the solenoid valve housing chamber with the outside, via the housing and a pump case. However, a volume formed between the air vent and solenoid valve housing chamber is small and the size of the solenoid valve housing chamber itself is large, the water entered from the air vent is possibly reached to the solenoid valve housing chamber.

In a case where water enters when the solenoid valve housing chamber is deformed by external pressure or a case where water enters when the solenoid valve housing chamber becomes negative pressure, water corresponding to a ratio of a total volume of the solenoid valve housing chamber including the air passage to a volume change thereof due to the external pressure or to a volume corresponding to the negative pressure may enter. Accordingly, an amount of water is in proportion to the total volume of the solenoid valve housing chamber. Therefore, an amount of water entering the solenoid valve housing chamber may be large when the volume of the solenoid valve housing chamber is large as above mentioned conventional hydraulic control system. Moreover, if a volume of the air passage between the air vent serving as a water entrance and the solenoid valve housing chamber is small, a height level of the water entered in the solenoid valve chamber becomes higher.

Further, when the volume of the solenoid valve housing chamber is large, an amount of water vapor that enters with outer air due to a change in the volume of the solenoid valve housing chamber may be large even if water does not enter. Therefore, dew is likely to condense in the solenoid valve housing chamber.

As mentioned above, the solenoid valve housing chamber with a large volume makes a possibility such that electric connection portions in the solenoid valve housing chamber are exposed to water and reliability of the hydraulic control system deteriorates.

### SUMMARY OF THE INVENTION

It is an object of the present invention to provide a hydraulic control system, with a simple configuration, that can prevent water entry to a solenoid valve housing chamber.

A first aspect of the present invention includes a solenoid valve housing chamber that is formed so as to be surrounded by a solenoid cover and a hydraulic unit housing. A solenoid valve position region of the solenoid valve housing chamber houses solenoid valves. In the solenoid valve position region, a lower space with a predetermined volume is formed at a lower side of the solenoid valves. An air vent which communicates the solenoid valve housing chamber with an outside thereof is formed at a lowermost portion, which is further lower than the lower space. A volume reduced portion is formed for decreasing a volume of an upper region that is upper than the solenoid valve position region of the solenoid valve housing chamber. According to these configurations, a total volume of the solenoid valve housing chamber can be decreased, compared with a case where the volume reduced portion is not formed.

Thus, an absolute amount of water that is entered from the air vent to the solenoid valve housing chamber, when the solenoid valve housing chamber is deformed by external pressure or when the solenoid valve housing chamber becomes negative pressure, decreases in accordance with decrease in the volume of the solenoid valve housing chamber. Therefore, since height level of water entered in the solenoid valve chamber becomes lower, it can prevent electric members such as the solenoid valves or electric connection portions from exposing to water.

Further, by decreasing the total volume of the solenoid valve housing chamber, a volume change of the solenoid valve housing chamber becomes small. An amount of water including water vapor that enters in the solenoid valve housing chamber due to the volume change can be small. Accordingly, dew is not likely to condense in the solenoid valve housing chamber.

The volume reduced portion is preferably formed by the solenoid valve or the hydraulic unit housing so that a surface of the solenoid cover facing with an opening of the hydraulic unit housing also abuts on the opening. In other words, a volume of an upper space of the solenoid valve position region sandwiched between a protruding portion of the solenoid cover and the hydraulic unit housing can be decreased. Such the volume reduced portion can be simultaneously formed as a part of a case of the solenoid valve housing chamber. Therefore, it is possible to easily manufacture the hydraulic control system without requiring design changes to be made, for example, the structure of the hydraulic unit or the installation position of the solenoid valve.

Moreover, in the lower space, electric supply terminals for a pump motor are preferably disposed at a position upper than the air vent. In this configuration, the height level of water that is entered in the lower space is suppressed. Therefore, by disposing the electric supply terminals for a pump motor at a position upper than the air vent, it is not exposed to water and reliability of the electric connection portions further increases.

According to the second aspect of the present invention, a labyrinth portion provided between a lower space formed below a solenoid valve position region in a solenoid valve housing chamber and an air vent formed at a lowermost portion of the solenoid valve housing chamber. The labyrinth portion includes partition plates for inhibiting fluid flow and communication holes formed in respective parts of the partition plates.

Therefore, the labyrinth portion is capable of inhibiting as well as allowing water entry through the air vent. The labyrinth portion with this configuration may be formed as a part of the lower space, and thus may be formed integrally and simultaneously with a casing of the solenoid valve housing portion. Therefore, it is possible to easily manufacture the hydraulic control system without requiring design changes to be made, for example, the structure of the hydraulic unit or the installation position of the solenoid valve.

### BRIEF DESCRIPTION OF THE DRAWINGS

Other objects, features and advantages of the present invention will be understood more fully from the following detailed description made with reference to the accompanying drawings. In the drawings:

FIG. 1 is a front view of a hydraulic control system according to an embodiment of the invention;

FIG. 2 is a side view of a solenoid cover viewed from a left side of FIG. 1;

FIG. 3 is an enlarged view of a left labyrinth portion of FIG. 2; and

FIG. 4 is a sectional view taken along line B-B of FIG. 3.

### DETAILED DESCRIPTION OF THE PREFERRED EMBODIMENTS

The present invention will be described further with reference to various embodiments in the drawings.

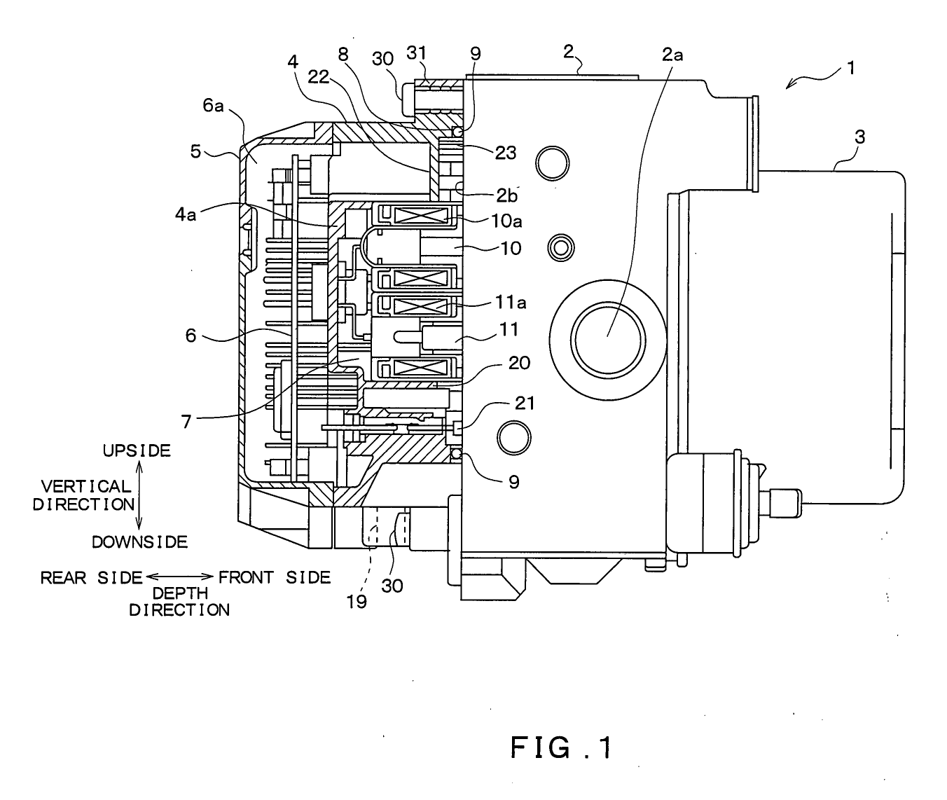

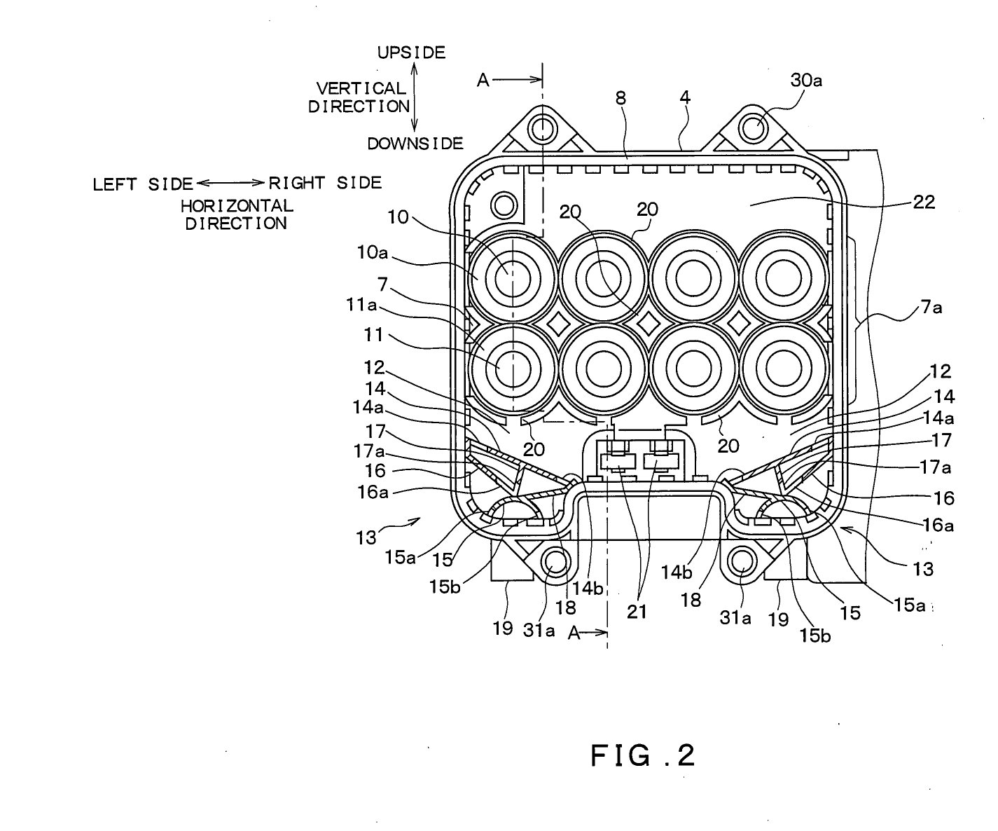

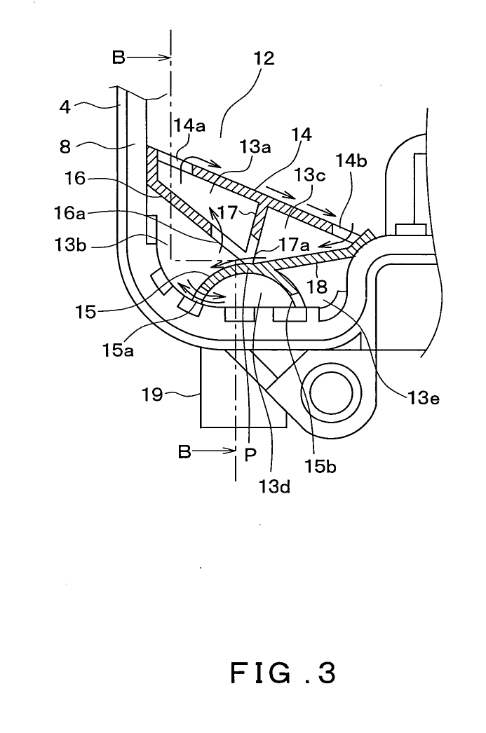

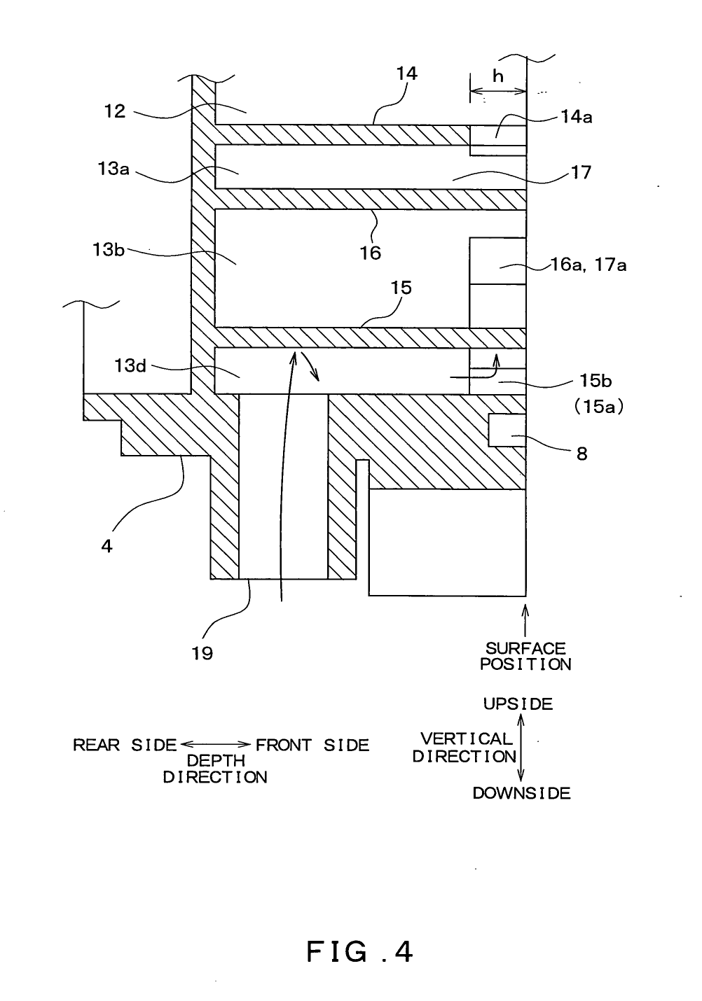

A hydraulic control system for a vehicle according to an embodiment of the present invention will be explained in detail referring to the drawings. FIG. 1 is a front view of a hydraulic control system 1 (including a partial sectional view cut along line A-A in FIG. 2); FIG. 2 is a side view of a solenoid cover 4 viewed from a left side of FIG. 1; FIG. 3 is an enlarged view of a left labyrinth portion 13 in FIG. 2; and FIG. 4 is a sectional view of the labyrinth portion 13 taken along line B-B as shown in FIG. 3. Respective top sides of the drawings in FIGS. 1 to 4 indicates an upside in the vertical direction when the hydraulic control system 1 is mounted in a vehicle body (hereinafter also simply referred to as “above” or “upside”). Furthermore, in FIGS. 1 and 4, a left side and a right side of the drawing are defined as a rear side and a front side in the depth direction (hereinafter also simply referred to as “a rear side” and “a front side”, respectively). In FIGS. 2 and 3, a left side and a right side of the respective drawings are defined as the left side and the right side in the horizontal direction (hereinafter also be simply referred to “a left side” and “a right side”, respectively). Note that FIG. 2 shows a configuration in which solenoids 10a and 11a are provided.

The hydraulic control system 1 according to the present embodiment is used, for example, to execute a vehicle control such as an anti-skid control, and is an integrated module including a hydraulic unit housing 2, a pump motor 3, a solenoid cover 4 and a circuit board cover 5. The hydraulic unit housing 2 houses a hydraulic mechanism which includes (i) a hydraulic pump 2a for regulating a hydraulic pressure or the like and (ii) solenoid valves 10 and 11 and the like. Further, the pump motor 3 drives the hydraulic pump 2a, and the solenoid cover 4 houses a portion around solenoids 10a and 11a. The circuit board cover 5 covers an electronic circuit board 6 for controlling the solenoid valves 10 and 11 as well as the pump motor 3. Note that the hydraulic unit housing 2 and the pump motor 3 are made of metal, and the solenoid cover 4 and the circuit board cover 5 are resin mold products.

One side of the solenoid cover 4 (on the rear side in the depth direction in FIG. 1) is covered with the circuit board cover 5 which is welded thereto. The solenoid cover 4 includes a partition 4a (a hatched portion in FIG. 1) running in the vertical direction. The electronic circuit board 6 is housed in a board housing chamber 6a which is surrounded in an air-tight manner by the partition 4a and the circuit board cover 5. Note that the partition 4a is provided with connectors (not shown) for supplying electricity from the electronic circuit board 6 to the pump motor 3 and the solenoid valves 10 and 11. The connectors are kept air-tight by filling a sealing agent therearound.

The solenoid cover 4 is connected to an opening 2b of the hydraulic unit housing 2 with screws 30 and 31, through packing 9 for air-tight purpose which fills a packing groove 8 provided in an outer peripheral portion of the solenoid cover 4. A space between the partition 4a of the solenoid cover 4 and the opening 2b of the hydraulic unit housing 2 serves as a solenoid valve housing chamber 7, and is kept air-tight, with the exception of a portion of air vents 19 which will be described later.

Four sets (four each in upper and lower lines) of the solenoid valves 10 and 11 serving as the hydraulic mechanism are aligned so that the eight solenoids 10a and 11a portions thereof are projected in the opening 2b of the hydraulic unit housing 2. The solenoids 10a and 11a are housed in a solenoid valve position region 7a which is close to a center of the solenoid valve housing chamber 7. The respective solenoids 10a and 11a are electrically connected to the electronic circuit board 6 through the partition 4a. A plurality of sleeve members 20 with a partially cylindrical shape are provided in the partition 4a so as to project toward the front in the depth direction. Each of the solenoids 10a and 11a is housed such that a periphery thereof is surrounded by the sleeve member 20, which enables the solenoids 10a and 11a to be easily positioned when assembly takes place.

Moreover, the partition 4a which is above the solenoids 10a and 11a and the like has an upper volume reduced portion 22 that is positioned such that a surface of the partition 4a abuts on the opening 2b of the hydraulic unit housing 2, that is, there is a reduced distance between the partition 4a and the hydraulic unit housing 2. Moreover, a side of the upper volume reduced portion 22 that contacts the solenoid 10a is formed into a cylindrical shape so as to be adjacent to the outer peripheral portion of the solenoid 10a. With the above described configuration, a volume of an upper space 23 which is formed between the upper volume reduced portion 22, the opening 2b of the hydraulic unit housing 2 and the four horizontally-aligned solenoids 10a is made as small as possible.

On the other hand, a lower space 12 is provided below the solenoid valve position region 7a, and, more specifically, between the four horizontally-aligned solenoids 11a and an outer wall of the solenoid cover 4. The lower space 12 is formed between the partition 4a and the hydraulic unit housing 2. Further, two labyrinth portions 13 are provided below the lower space 12 so as to be symmetrical with each other in the left-right direction as shown in FIG. 2. The labyrinth portions 13 form an air passage that bends a portion between the lower space and an outside of the solenoid cover 4. Respective air vents 19 which communicate with the outer wall and which serve as water drains are provided below each of the labyrinth portions 13.

In the lower space 12, a pair of electric supply terminals 21 for the pump motor 3 (hereinafter referred to as pump-motor electric supply terminals 21) project from the partition 4a toward the front in the depth direction in a portion between the two labyrinth portions 13. The position of the pump-motor electric supply terminal 21 in the up-down direction is higher than that of a lower communication hole 14b provided in a first partition plate 14, to be described later, of each labyrinth portion 13.

As mentioned above, in the solenoid valve housing chamber 7, at a portion above than the four horizontally-aligned solenoids 10a, an upper volume reduced portion 22 is formed such that a part of the partition 4a protrudes toward the front in the depth direction. In other word, the upper volume reduced portion 22 is formed such that the partition 4a abuts on the hydraulic unit housing 2. Therefore, a space above the solenoids 10a is extremely small. Further, since the solenoids 10a and 11a lined up two lines and the sleeve member 20 are adjacent to each other, the volume of the solenoid valve position region 7a is also extremely small.

Accordingly, a total volume of the solenoid valve housing chamber 7 formed by the solenoid cover 4 and the hydraulic unit housing 2 is substantially equal to a volume below than the horizontally-aligned solenoids 11a. That is, the total volume of the solenoid valve housing chamber 7 is approximately equals to a volume corresponding to a volume of the pump-motor electric supply terminals 21 subtract from a volume of the lower space 12 and a volume of the labyrinth portion 13.

There are some cases where water entry into the solenoid valve housing chamber 7 from the air vent 19 caused by change in an air pressure therein. For example, this occurs because the hydraulic control system 1 itself is immersed in water, whereby water pressure is applied to the air vent 19. This also occurs when the negative pressure of the solenoid valve housing chamber 7 caused by decreasing in temperature thereof when the water is poured to the hydraulic control system 1 with high temperature. Further, this occurs even if real water does not enter. That is, outer air entry occurs when the volume of the solenoid valve housing chamber 7 changes in accordance with change in outside temperature or external pressure. Thus, water vapor included in the outer air enters in the solenoid valve housing chamber 7, and, therefore, dew is likely to condense therein.

In the case where water enters in the solenoid valve housing chamber 7 by applying water pressure to the air vent 19 when the hydraulic control system 1 itself is immersed in water or in the case where water enters in the solenoid valve housing chamber 7 when it becomes the negative pressure, an outer pressure and an inner pressure of the solenoid valve housing chamber 7 are balanced after water entry. This is because water corresponding to a ratio of a total volume of the solenoid valve housing chamber 7 including the air passage such as the labyrinth portion 13 to a volume change thereof due to the external pressure or to a volume corresponding to the negative pressure may enter the solenoid valve housing chamber 7. Otherwise, an amount of air to be entered to the solenoid valve housing chamber 7 due to volume change thereof is in proportion to the total volume of the solenoid valve housing chamber 7.

Thus, an absolute amount of water to be entered is in proportion to the total volume of the solenoid valve housing chamber 7. Accordingly, in order to reduce the absolute amount of water to be entered, it is necessary to reduce the total volume of the solenoid valve housing chamber 7.

In the present embodiment, since the total volume of the solenoid valve housing chamber 7 is reduced by providing the upper volume reduced portion 22, the absolute amount of water to be entered reduces. Therefore, a height level of the water that is entered in the solenoid valve housing chamber 7 is suppressed. Moreover, dew is not likely to condense in the solenoid valve housing chamber 7 because the amount of the water vapor that enters in the solenoid valve housing chamber 7 due to the volume change can be reduced.

In addition, in the present embodiment, an essential volume of the solenoid valve housing chamber 7 is concentrated at a portion below the solenoid valve portion region 7a by providing the upper volume reduced portion 22. Thus, the height level of the water that is entered due to the pressure change in the solenoid valve housing chamber 7 becomes lower than a settled level in the lower space 12. The settled level corresponds to a position at which the outside pressure and inside pressure of the solenoid valve housing chamber 7 is balanced. Further, as mentioned above, because the volume in the solenoid valve housing chamber 7 is reduced, the amount of water that is entered can be reduced. Therefore, rise of the height level of the water is suppressed.

In the present embodiment, the pump-motor electric supply terminals 21 are disposed at a position above the air vent 19. Accordingly, it is possible to prevent the pump-motor electric supply terminals 21 from exposing to the water.

Hereinafter an explanation will be given about the labyrinth portion 13 on the left side in FIG. 2, referring to FIGS. 3 and 4. Note that since the labyrinth portion 13 on the right side is symmetrical with the labyrinth portion 13 on the left side, the same structures will be denoted by the same reference numbers and the explanation thereof will be omitted.

The labyrinth portion 13 is configured by first to fifth partition plates 14 to 18. The first to fifth partition plates 14 to 18 are so as to project from the partition 4a toward the front in the depth direction so as to contact the hydraulic unit housing 2 through the partition 4a. Note that, in FIG. 3, portions at which the partition plates 14 to 18 contact the hydraulic unit housing 2 are hatched. Further, a position in FIG. 4 at which each of the partition plates 14 to 18 contacts the hydraulic unit housing 2 will be referred to herein as a surface position of the solenoid cover 4 (hereinafter, simply referred to as a “surface position”).

The first partition plate 14, formed as a flat plate, is positioned farthest (among the partition plates 14 to 18) from the air vent 19 in the vertical direction, that is, the first partition plate 14 is positioned so as to contact the lower space 12 and inclined with respect to the horizontal direction. An upper communication hole 14a is provided in an inclined upper portion of the first partition plate 14. The upper communication hole 14a is cut into a rectangular shape with a predetermined width and a height h, which is the height from the surface position to the rear in the depth direction. Note that all other communication holes mentioned in this specification hereunder, are also formed with a rectangular shape.

Also, a lower communication hole 14b is provided in an inclined lower portion of the first partition plate 14. The lower communication hole 14b is cut into a rectangular shape with a predetermined width and a height h, which is the height from the surface position to the rear in the depth direction. Accordingly, the upper side of the first partition plate 14 functions as a drainage path by which water that has entered the lower space 12 through the upper communication hole 14a flows down to the lower communication hole 14b.

The second partition plate 15 is configured by a semi-cylindrical plate extending in the depth direction and is adjacent to the air vent 19. Two communication holes 15a and 15b are provided at respective semi-cylindrical ends of the second partition plate 15. Each of the communication holes 15a and 15b is cut into a rectangular shape with a predetermined width and a height h, which is the height from the surface position to the rear in the depth direction. Note that the air vent 19 is positioned rearward in the depth direction of the surface position of the solenoid cover 4. On some occasions water may flood into, that is, flow in a high flow rate, because, for example, the pressure in the solenoid valve housing chamber 7 becomes negative. However, even in this case, water unavoidably strikes a semi-cylindrical inner face of the second partition plate 15 as shown by an arrow in FIG. 4. Then, the water reaches the communication holes 15a and 15b after the momentum of the water has been reduced. Therefore, the water is inhibited from reaching the communication holes 15a and 15b directly through the air vent 19. Furthermore, since the momentum of the water is reduced, water entry toward the lower space 12 through the second partition plate 15 is inhibited.

The first partition plate 14 is connected to the second partition plate 15 through the third to fifth partition plates 16 to 18. The third partition 16, configured by a flat plate, is disposed so as to connect between the vicinity of the upper communication hole 14a of the first partition plate 14 and a semi-circular top P of the second partition plate 15 in the vertical direction. Moreover, a communication hole 16a is provided below the third partition plate 16 in the vertical direction, that is, in the vicinity of the semi-circular top P of the second partition plate 15. The communication hole 16a is cut by a height h, which is the height from the surface position to the rear in the depth direction for a predetermined width.

The fourth partition plate 17, configured by a flat plate, is disposed so as to connect a substantially central portion of the first partition plate 14 in the vertical plane and the semi-circular top P of the second partition plate 15. Moreover, a communication hole 17a is provided vertically below the fourth partition plate 17, that is, in the vicinity of the semi-circular top P of the second partition plate 15, so as to be continuous with the communication hole 16a of the third partition plate 16. The communication hole 17a is cut into a rectangular shape, by an amount corresponding to a height h, to the rear in the depth direction from the surface position for a predetermined width.

Note that the width of cut-out portion of the communication hole 16a is larger than that of the cut-out portion of the communication hole 17 in the vertical plane. That is, the communication hole 16a has a larger opening area than the communication hole 17a.

The fifth partition plate 18, configured by a flat plate, is disposed so as to connect the vicinity of the lower communication hole 14b of the first partition plate 14 and the semi-circular top P of the second partition plate 15 in the vertical plane. Note that a communication hole is not formed in the fifth partition 18.

In the labyrinth portion 13, five segmented regions 13a, 13b, 13c, 13d and 13e that are communicated with each other are defined by the first to fifth partition plates 14 to 18 disposed as described above and the outer wall of the solenoid cover 4.

The labyrinth portions 13 provided with the partition plates 14 to 18 and the communication holes 14a to 17a can be formed at the same time as the upper volume reduced portion 22 as a part of the solenoid cover 4. Furthermore, the labyrinth portion 13 is provided below the lower space 12, which enables both design flexibility and simplicity. Note that the labyrinth portion 13 may be regarded as a portion of the lower space 12.

Water flows in the labyrinth portion 13 with the above described configuration as follows. When water enters the segmented region 13d through the air vent 19, the water enters the segmented region 13b through the communication hole 15a. Note that the communication region 13e only communicates with the communication hole 15b, so few water enters the communication region 13e.

On some occasions, the momentum, that is, the flow rate, of the entering water that enters the segmented region 13d through the air vent 19 may be large. In this case, the entering water strikes the cylindrical inner surface of the first partition plate 15, and bounces back in the reverse direction toward the air vent 19. Further, in the segmented region 13d, the direction in which the water strikes the cylindrical inner surface and in which the water flows through the air vent 19 is almost at right angles to the direction in which the water flows from the air vent 19 to the communication hole 15a. Accordingly, the momentum of the water is effectively reduced. Then, the water passes through the segmented region 13d, the communication hole 15a, the segmented region 13b, the communication hole 16a, the segmented region 13a, the upper communication hole 14a. Finally, the water enters the lower space 12.

Since the communication hole 16a has a larger opening area than the communication hole 17a, the water in the segmented region 13b mainly enters the segmented region 13a through the communication hole 16a. That is, the communication hole 16a functions as a communication hole for inflow. Furthermore, on occasions, the water may enter the segmented region 13b through the communication hole 15a with large momentum. Even in this case, however, since the third partition plate 16 is provided in the direction where the water flows, the entering water strikes the third partition 16 and the momentum of the water is reduced. Therefore, water is inhibited from directly reaching the upper communication hole 14a. Accordingly, water entry through the upper communication hole 14a to the lower space 12 is inhibited.

Then, the water which enters the lower space 12 flows down the surface of the first partition plate 14 from the upper communication hole 14a to the lower communication hole 14b. The water passes through the lower communication hole 14b, the segmented region 13c, the communization hole 17a, the segmented region 13b, the communication hole 15a, the segmented region 13d and the air vent 19. Accordingly, the water is drained outside of the solenoid cover 4. As described above, the communication hole 17a serves as a communication hole for drainage.

Since the labyrinth portion 13 is configured as described above, the second partition plate 15 inhibits water entry through the air vent 19. Further, the inclined configuration of the first partition plate 14 enables the water which enters the lower space 12 to be quickly drained through the lower communication hole 14b.

Accordingly, it is difficult for water to enter the lower space 12 of the solenoid cover 4. Furthermore, even if the water enters the lower space 12, the water can be quickly drained to the outside.

Furthermore, in the lower space 12, the pump-motor electric supply terminal 21 is positioned above the lower communication hole 14b of the partition plate 14 in the vertical direction. Therefore, it is possible to inhibit the pump-motor electric supply terminal 21 through which a relatively large current passes from being immersed in the water, since the water that enters the lower space 12 is quickly drained out through the lower communication hole 14b. Accordingly, reliability of the hydraulic control system 1 is improved.

Note that when the air vent 19 is immersed in water, and the height level of water gradually increases, the flow rate of the water which flows in through the air vent 19 is low. In this case, the height level of water inside the labyrinth portion 13 gradually rises at a rate that is equal for all of the segmented regions 13a, 13b and 13c. Further, the water enters the lower space 12 through the lower communication hole 14b. Meanwhile, when the height level of water decreases, the water is quickly drained through the lower communication hole 14b. Accordingly, it is possible to keep the height level of water in the lower space 12 to as low a level as possible.

Modifications

In the above embodiment, the upper volume reduced portion 22 is formed such that a part of the partition 4a protrudes toward the front in the depth direction. In other word, the upper volume reduced portion 22 is formed such that the partition 4a abuts on the opening 2b of the hydraulic unit housing 2. According to this configuration, the upper space 23 which is formed between the upper volume reduced portion 22 and the opening 2b of the hydraulic unit housing 2 is made as small as possible.

However, the upper volume reduced portion 22 is not limited above mentioned configuration. For example, a upper volume reduced portion can alternatively be formed by the hydraulic unit housing 2 rather than the partition 4a. In this case, in order to reduce the volume of the solenoid valve housing chamber 7 and the volume of the upper space 23 that is upper than the solenoid valve position region 7a, a part of the hydraulic unit housing 2 is protruded toward the rear side in the depth direction to abut on the partition 4a. Alternately, an outer wall of the solenoid cover 4 can be formed so as to abut the solenoids 10a for eliminating the upper volume 23.

While the above description is of the preferred embodiments of the present invention, it should be appreciated that the invention may be modified, altered, or varied without deviating from the scope and fair meaning of the following claims.

1. A hydraulic control system for a vehicle, comprising:
a hydraulic unit housing which houses a hydraulic mechanism including a pump motor for regulating a hydraulic pressure for a vehicle control and a plurality of solenoid valves; and
a solenoid cover which is attached to the hydraulic unit housing so as to cover an opening that is formed at one end of the hydraulic unit housing, wherein
the solenoid valves are housed in a solenoid valve position region in a solenoid valve housing chamber formed by the opening and the solenoid cover, and
in the solenoid valve housing chamber,
an air vent which communicates the solenoid valve housing chamber with an outside thereof is formed at a lowermost portion,
a lower space with a predetermined volume is formed between the solenoid valve position region and the air vent, and
a volume reduced portion that is disposed at an opposite side to the lower space with respect to the solenoid valve position region.

2. The hydraulic control system for a vehicle according to claim 1, wherein
the volume reduced portion is formed by a part of the solenoid valve or a part of the hydraulic unit housing so that a surface of the solenoid cover facing with an opening of the hydraulic unit housing also abuts on the opening.

3. The hydraulic control system for a vehicle according to claim 1, further comprising;
an electric supply terminals for a pump motor are disposed at a position above the air vent in the lower space.

4. The hydraulic control system for a vehicle according to claim 2, further comprising;
an electric supply terminals for a pump motor are disposed at a position above the air vent in the lower space.

5. The hydraulic control system for a vehicle according to claim 1, further comprising;
a labyrinth portion formed between the air vent and the lower space, the labyrinth portion including at least one partition plate that inhibits flow of a fluid between the air vent and the lower space and at least one communication hole formed in a part of the partition plate so as to allow flow of the fluid.

6. The hydraulic control system for a vehicle according to claim 2, further comprising;
a labyrinth portion formed between the air vent and the lower space, the labyrinth portion including at least one partition plate that inhibits flow of a fluid between the air vent and the lower space and at least one communication hole formed in a part of the partition plate so as to allow flow of the fluid.

7. The hydraulic control system for a vehicle according to claim 3, further comprising;
a labyrinth portion formed between the air vent and the lower space, the labyrinth portion including at least one partition plate that inhibits flow of a fluid between the air vent and the lower space and at least one communication hole formed in a part of the partition plate so as to allow flow of the fluid.

8. The hydraulic control system for a vehicle according to claim 4, further comprising;
a labyrinth portion formed between the air vent and the lower space, the labyrinth portion including at least one partition plate that inhibits flow of a fluid between the air vent and the lower space and at least one communication hole formed in a part of the partition plate so as to allow flow of the fluid.
